(19) United States
(12) Patent Application Publication
(10) Pub. No.: US 2004/0107227 A1
(43) Pub. Date: Jun. 3, 2004

(54) Method for efficient implementation of dynamic lock-free data structures with safe memory reclamation

(75) Inventor: Maged M. Michael, Danbury, CT (US)

Correspondence Address: F. CHAU & ASSOCIATES, LLP, Suite 501, 1900 Hempstead Turnpike, East Meadow, NY, 11554, US

(73) Assignee: International Business Machines Corporation, Armonk, NY (US)

(21) Appl. No.: 10/308,449

(22) Filed: Dec. 3, 2002

(51) Int. Cl. G06F 17/30; G06F 12/00

(52) U.S. Cl. 707/206

(57) ABSTRACT

A method for safe memory reclamation for dynamic lock-free data structures employs a plurality of shared pointers, called hazard pointers, that are associated with each participating thread. Hazard pointers either have null values or point to nodes that may potentially be accessed by a thread without further verification of the validity of the local references used in their access. Each hazard pointer can be written only by its associated thread, but can be read by all threads. The method requires target lock-free algorithms to guarantee that no thread can access a dynamic node at a time when it is possibly unsafe (i.e., removed from the data structure), unless one or more of its associated hazard pointers has been pointing to the node continuously, from a time when it was not removed.

### BACKGROUND OF THE INVENTION

1. Field of the Invention

The present invention relates generally to memory management, and more particularly, to techniques for managing shared access among multiple threads.

2. Background of the Invention

A shared object is lock-free (also called non-blocking) if it guarantees that in a system with multiple threads attempting to perform operations on the object, some thread will complete an operation successfully in a finite number of system steps even with the possibility of arbitrary thread delays, provided that not all threads are delayed indefinitely. By definition, lock-free objects are immune to deadlock even with thread failures and provide robust performance even when faced with inopportune thread delays. Dynamic lock-free objects have the added advantage of arbitrary size.

However, there are various problems associated with lock-free objects. For instance, it may be difficult to ensure safe reclamation of memory occupied by removed nodes. In a lock-based object, when a thread removes a node from the object, it can be guaranteed that no other thread will subsequently access the contents of the removed node while still assuming its retention of type and content semantics. Consequently, it is safe for the removing thread to free the memory occupied by the removed node into the general memory pool for arbitrary future reuse.

This is not the case for a lock-free object. When a thread removes a node, it is possible that one or more contending threads, in the course of their lock-free operations, have earlier read a pointer to the subsequently removed node, and are about to access its contents. A contending thread might corrupt the shared object or another object, if the thread performing the removal were to free the removed node for arbitrary reuse. Furthermore, on some systems, even read access to freed memory may result in fatal access errors.

For most dynamic lock-free algorithms, in order to guarantee lock-free progress, all participating threads must have unrestricted opportunity to operate on the object, including access to all or some of its nodes, concurrently. When a thread removes a node from the object, other threads may hold references to the removed node. The memory reclamation problem is how to allow removed nodes to be reclaimed, and guarantee that no thread can access the contents of a node while it is free.

A different but related problem is the ABA problem. It happens when a thread in the course of operating on a lock-free object, reads a value A from a shared location, and then other threads change the location to a value B and then A again. Later, when the original thread compares the location, e.g., using compare-and-swap (CAS), and finds it equal to A, it may corrupt the object.

For most dynamic lock-free objects, the ABA problem happens only if a node is removed from the object and then reinserted in the same object while a thread is holding an old reference to the node with the intent to use that reference as an expected value of an atomic operation on the object. This can happen even if nodes are only reused but never reclaimed. For these objects, the ABA problem can be prevented if it is guaranteed that no thread can use the address of a node as an expected value of an atomic operation, while the node is free or ready for reuse.

Another significant problem associated with some important lock-free data structures based on linked-lists is that they require garbage collection (GC) for memory management, which is not always available, and hence limit the portability of such data structures across programming environments.

### SUMMARY OF THE INVENTION

According to various embodiments of the present invention, a computer-implemented method for managing a shared dynamic data structure in a multithreaded operating environment includes setting a hazard pointer to an address of a portion of the data structure to be removed, removing the portion of the data structure, and ensuring that memory associated with the removed portion of the data structure is freed only when the hazard pointer no longer points to the removed portion of the data structure.

Each thread sharing the dynamic data structure will preferably have at least one hazard pointer which may be set to a null value or to portions of the data structure that are accessed by the thread without verification of references used in their access. The thread setting the hazard pointer ensures that it accesses a portion of the data structure to be removed, only if the hazard pointer continuously points to the portion of the data structure from a time it was not removed. Another thread can then free the removed portion of the data structure for arbitrary reuse. Operations on the data structure are guaranteed to proceed concurrently without any one of the operations preventing other operations from completing indefinitely.

The data structure used can be a linked list and, in this case, the removed portion of the data structure will be a node. The linked-list data structure may be used to implement a stack, a queue, a heap, and a hash table, etc. Other types of dynamic data structures may also be used, such as, for example, graphs and trees. The method may be used in conjunction with most known algorithms.

Removed portions of the data structure are scanned to determine if they are to be freed. The removed portions of the data structure may be scanned when the number of removed portions exceeds a predetermined value.

Alternatively, the scanning step may more efficiently take place if it occurs when the number of removed portions equals or exceeds a value proportionate to the number of threads.

The scanning step can be further optimized by creating a sorted list of hazard pointers, and searching the sorted list of hazard pointers to determine matches between any of the hazard pointers and the removed portions. Preferably, the searching step is performed using a binary search. Null hazard pointers should be removed from the list of hazard pointers to reduce search time.

For efficient results, hazard pointers associated with threads not using the data structure should be set to null or other value indicating they are not in use.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a block diagram of a computer processing system to which the present invention may be applied;

FIG. 2 illustrates a version of a lock-free stack with hazard pointers;

FIGS. 3(a)-(c) illustrate exemplary structures and operations of a technique for memory reclamation;

FIG. 4 illustrates an exemplary hash table based on linked-lists;

FIG. 5 illustrates exemplary data structures used by a hash table algorithm based on lock-free GC-independent linked-list algorithm;

FIG. 6 illustrates exemplary hash table operations using the exemplary data structures of FIG. 5; and

FIGS. 7(a)-(b) illustrate an exemplary lock-free GC-independent list-based set algorithm with hazard pointers.

### DESCRIPTION OF PREFERRED EMBODIMENTS

It is to be understood that the present invention may be implemented in various forms of hardware, software, firmware, special purpose processors, or a combination thereof. Preferably, the present invention is implemented as software. The program may be uploaded to, and executed by, a machine comprising any suitable architecture.

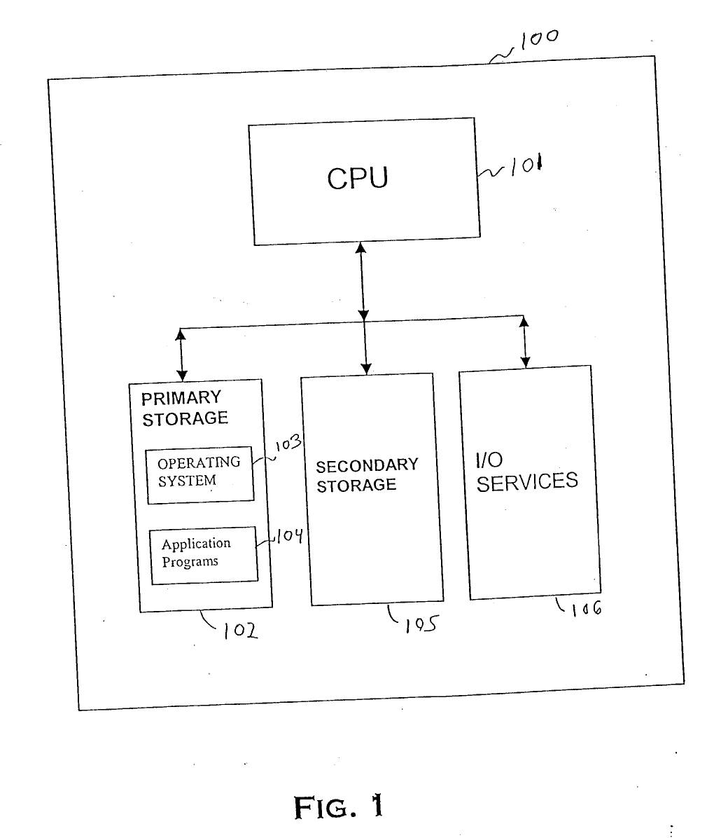

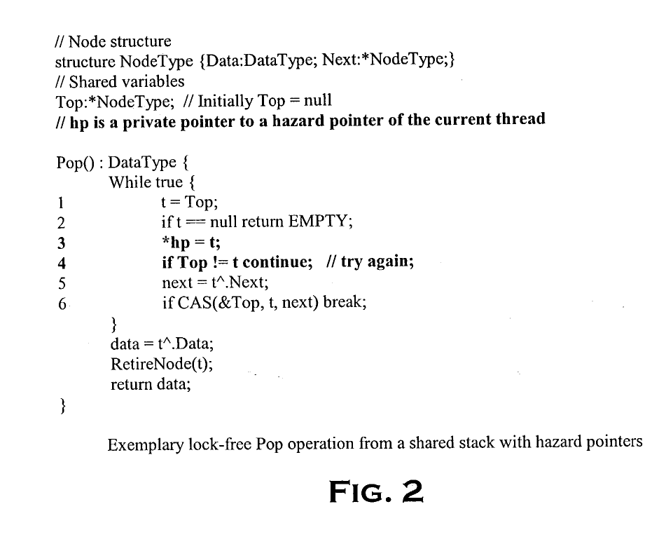

FIG. 1 is a block diagram of a computer processing system 100 to which the present invention may be applied according to an embodiment of the present invention. The system 100 includes at least one central processing unit (“CPU”), such as CPU 101, a primary storage 102, a secondary storage 105, and input/output (“I/O”) devices 106. An operating system 103 and application programs 104 are initially stored in the secondary storage 105 and loaded to the primary storage 102 for execution by the CPU 101. A program, such as an application program 104, that has been loaded into the primary storage 102 and prepared for execution by the CPU 101 is called a process. A process includes the code, data, and other resources that belong to a program. A path of execution in a process is called a thread. A thread includes a set of instructions, related CPU register values, and a stack. A process has at least one thread. In a multithreaded operating system, a process can have more than one thread. The thread is the entity that receives control of the CPU 101.

Those skilled in the art will appreciate that other alternative computing environments may be used without departing from the spirit and scope of the present invention.

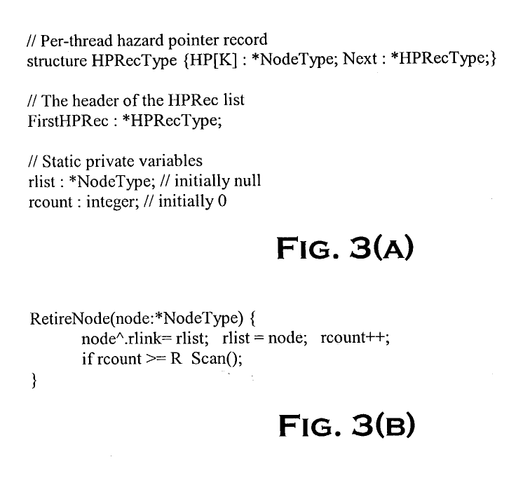

FIG. 2 shows a version of a lock-free stack (based on the well-known IBM freelist algorithm) augmented with hazard pointers per the new method (indicated in bold type), that guarantees that no dynamic node is accessed while free and prevents the ABA problem. The pointer hp is a static private pointer to the hazard pointer associated with the executing thread, and the procedure RetireNode is part of the new method. The Push routine need not change, as no dynamic node that is possibly free is accessed, and the CAS is not ABA-prone. In the Pop routine the pointer t is used to access a dynamic node t\hat{ } and holds the expected value of an ABA-prone CAS. By setting the hazard pointer to t (line 3) and then checking that t\hat{ } is not removed (line 4), it can be guaranteed that the hazard pointer is continuously pointing to t\hat{ } from a point when it was not removed (line 4) until the end of hazards, i.e., accessing t\hat{ } (line 5) and using t to hold the expected value of an ABA-prone CAS (line 6).

The method prevents the freeing of a node continuously pointed to by one or more hazard pointers of one or more threads from a point prior to its removal. When a thread retires a node by calling RetireNode, it stores it in a private list.

After accumulating a certain number R of retired nodes, the thread scans the hazard pointers for matches for the addresses of the accumulated nodes. If a retired node is not matched by any of the hazard pointers, then the thread may free that node making its memory available for arbitrary reuse. Otherwise, the thread keeps the node until its next scan of the hazard pointers which it performs after the number of accumulated deleted nodes reaches R again.

By setting R to a number such that R=K*P+Ω(P) where P is the number of participating threads, and sorting a private list of snapshots of non-null hazard pointers, every scan of the hazard pointers is guaranteed to free Θ(R) nodes in O (R log p) time, when p threads have non-null hazard pointers. Thus, the amortized time complexity of processing each deleted node until it is freed is only logarithmically adaptive, i.e., constant in the absence of contention and O(log p) when p threads are operating on the object during the scan of their associated hazard pointers. The method also guarantees that no more than PR retired nodes are not yet freed at any time regardless of thread failures and delays.

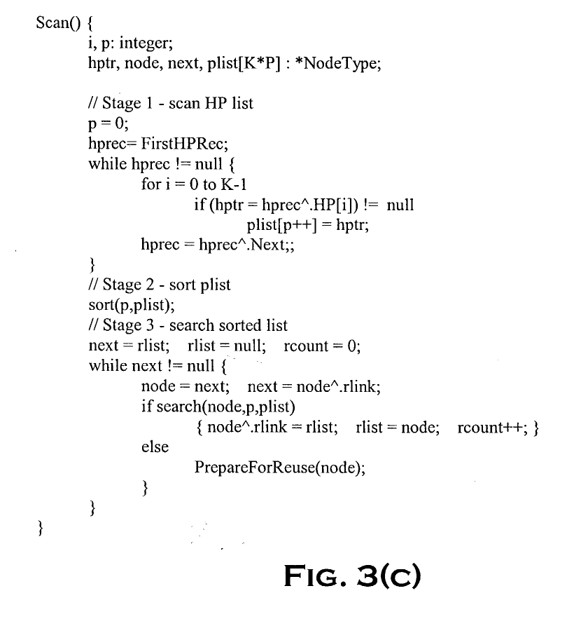

FIG. 3(a) shows the shared and private structures used by this algorithm. The main shared structure is the linked list of per-thread hazard pointer records (HPRecs). The list is initialized to contain one HPRec per participating thread.

FIG. 3(b) shows the RetireNode routine, where the retired node is inserted into the thread's retired node list and the length of the list is updated.

For simplicity, a separate field rlink (for retirement link) can be used to form the private list of retired nodes. However, in most algorithms there is always at least one field in the node structure that could be safely reused as the rlink field, without need for extra space per node. In cases where the method is used to support multiple objects of different types or an object with multiple node structures, the rlink field can be placed at a fixed offset in the target node types. If it is not possible or not desirable to make any assumptions about the node structures, the thread can allocate a private surrogate node that contains the rlink field and a pointer to the retired node.

Whenever the size of a thread's list of retired nodes reaches a threshold R, the thread scans the list of hazard pointers using the Scan routine. R can be chosen arbitrarily. However, in order to guarantee an amortized processing time per reclaimed node that is logarithmic in the number of threads, R must be set such that R=KP+Ω(P).

FIG. 3(c) shows an exemplary Scan routine. The scan consists of three stages. The first stage involves scanning the HP list for non-null values. Whenever a non-null value is encountered, it is inserted in a local pointer list plist. The counter p holds the size of plist. The second stage of the scan involves sorting plist to allow efficient binary search in the third stage. The third stage of the scan involves checking each node in rlist against the pointers in plist. If the binary search yields no match, the node is determined to be ready for reclamation or reuse. Otherwise, it is retained in rlist until the next scan by the current thread.

A comparison-based sorting algorithm may be employed that takes Θ(p log p) time, such as heap sort, to sort plist} in the second stage. Binary search in the third stage takes O(log p) time. We omit the code for these algorithms, as they are widely known sequential algorithms.

The task of the memory management method is to determine when a retired node is ready for reuse safely while allowing memory reclamation and/or eliminating the ABA problem. Thus, the definition of the PrepareForReuse routine, i.e., making a node that is ready for reuse available for reuse, is not an integral part of the memory management method. A possible implementations of that routine is to reclaim the node for arbitrary reuse using the standard library call, e.g., free. The new method allows more freedom in defining such a routine than prior memory management methods.

The following are some practical considerations for improving performance and/or enhancing flexibility:

For most objects especially constant time objects such as stacks and queues, plist is likely to contain few unique values. Removing duplicates from plist after sorting it in the second stage of Scan can improve the search time in the third stage.

Each hazard pointer is written only by its owner thread, and read rarely (in Scan) by other threads. To avoid the adverse performance effect of false sharing and thus to allow most accesses to hazard pointers by their owner thread to be cache hits, HP records should be aligned such that no two hazard pointers belonging to two different threads are collocated in the same cache line.

In order to reduce the overhead of calling the standard allocation and deallocation procedures (e.g., malloc and free) for every node allocation and deallocation, each thread can maintain a limited size private list of free nodes. When a thread runs out of private free nodes it allocates new nodes, and when a thread accumulates too many private free nodes it deallocates the excess nodes.

If the actual maximum number of participating threads P is mostly small but occasionally can be large, initializing the HP list to include P HP records may be space inefficient. A more space efficient alternative is to start with an empty HP list and insert a new HP record in the list upon the creation of each new thread. To insert a new HP record safely and in a lock-free manner we can use a simple push routine such as:

do{old=FirstHPRec; newhprec\hat{ }.Next=old;} until CAS(&FirstHPRec,old,newhprec);

Note that this routine is lock-free but not wait-free and uses single-word CAS, but the main algorithm (RetireNode and Scan) remain wait-free and use only single-word reads and writes.

In some applications, threads are created and destroyed dynamically. In such cases it may be desirable to allow HP records to be reused. Adding a one-bit flag to each HP record can serve as an indicator if the HP record is in use or available for reuse. Before retiring a thread can clear the flag, and when a new thread is created it can search the HP list for an available HP record and set its flag using CAS (test-and-set is sufficient). If no HP records are available a new one can be added as described in the previous item.

Since a thread may have leftover retired nodes not yet identified as ready for reuse, a pointer and an integer fields can be added to the HP record structure such that a retiring thread can pass the values of its rlist and rcount variables to the next thread that inherits the HP record. The new thread initializes its rlist and rcount variables to these values left by the retiring thread.

On a related matter, having threads retiring and leaving behind their rlists non-empty, may be undesirable in cases where the number of active threads decreases and never rises to prior higher levels. The nodes in some rlists may never be identified as reclaimable, although they may be so. To prevent this, we can use a second level of amortization, such that whenever a thread completes Ω(P) consecutive Scans, it performs one superscan, where it scans the HP list one HP record at a time, whenever it finds an HP record available, succeeds in acquiring it in a single attempt (thus superscan is wait-free), and finds its rlist to be non-empty, it performs a Scan on that list. Doing so guarantees that in the absence of thread failures, each node will eventually be identified as ready for reclamation. The superscan operation is wait-free. Since superscans are performed infrequently, the O(log p) amortized time complexity remains valid.

For a target dynamic lock-free object to use the new method to allow safe memory reclamation and/or to prevent the ABA problem, it must satisfy the following condition. Whenever a thread uses the address of a dynamic node in a hazardous manner (i.e., access the dynamic node or use it in an ABA-prone operation) while the node is possibly removed by another thread, it must guarantee that one or more of its associated hazard pointers has been pointing to the node continuously since it was not removed.

A secondary optional condition is to guarantee that whenever a thread is not operating on lock-free objects its hazard pointers are null. This is needed only to make the time complexity of the method adaptive, that is dependent on contention and not on the maximum number of threads.

In addition to the memory management method, a lock-free linked-list algorithm that can be used by a variety of objects including as a building block of a lock-free hash table algorithm is also herein disclosed. This method is independent of support for garbage collection (GC).

Experimental results show significant performance advantages of the new algorithm over the best known lock-free as well as lock-based hash table implementations. The new algorithm outperforms the best known lock-free algorithm by a factor of 2.5 or more, in all lock-free cases. It outperforms the best lock-based implementations, under high and low contention, with and without multiprogramming, often by significant margins.

A hash table is a space efficient representation of a set object K when the size of the universe of keys U that can belong to K is much larger than the average size of K. The most common method of resolving collisions between multiple distinct keys in K that hash to the same hash value h is to chain nodes containing the keys (and optional data) into a linked list (also called bucket) pointed to by a head pointer in the array element of the hash table array with index h. The load factor α is the ratio of |K| to m , the number of hash buckets.

With a well-chosen hash function h(k) and a constant average α, operations on a hash table are guaranteed to complete in constant time on the average. This bound holds for shared hash tables in the absence of contention.

The basic operations on hash tables are: Insert, Delete and Search. Most commonly, they take a key value as an argument and return a Boolean value. Insert (k) checks if nodes with key k are in the bucket headed by the hash table array element of index h(k). If found (i.e.,kεK ), it returns false. Otherwise it inserts a new node with key k in that bucket and returns true.

Delete(k) also checks the bucket with index h(k) for nodes with key k. If found, it removes the nodes from the list and returns true. Otherwise, it returns false. Search(k) returns true if the bucket with index h(k) contains a node with key k, and returns false otherwise.

For time and space efficiency most implementations do not allow multiple nodes with the same key to be present concurrently in the hash table. The simplest way to achieve this is to keep the nodes in each bucket ordered by their key values.

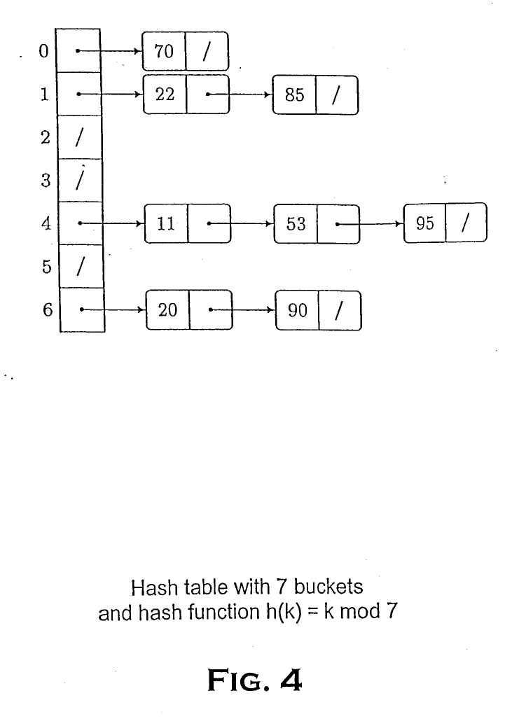

FIG. 4 shows a list-based hash table representing a set K of positive integer keys. It has seven buckets and the hash function h(k)=k mod 7.

By definition, a hash function maps each key to one and only one hash value. Therefore, operations on different hash buckets are inherently disjoint and are obvious candidates for concurrency. Generally, hash table implementations allow concurrent access to different buckets or groups of buckets to proceed without interference. For example if locks are used, different buckets or groups of buckets can be protected by different locks, and operations on different bucket groups can proceed concurrently. Thus, shared set implementations are obvious building blocks of concurrent hash tables.

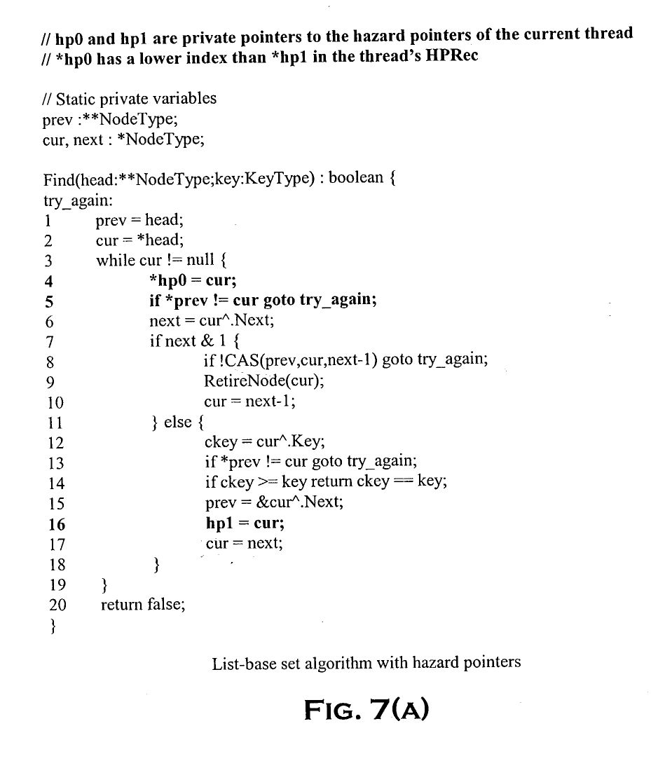

The linked-list method is GC-independent and is compatible with simple and efficient memory management methods such as hazard pointers (explained above) and the well known ABA-prevention tags (update counters) used with freelists The algorithm is GC-independent and compatible with all memory management methods. We focus on a version using the hazard pointer method as explained above. FIG. 6 shows the data structures and the initial values of shared variables used by the algorithm. The main structure is an array T of size M. Each element in T is basically a pointer to a hash bucket, implemented as a singly linked list.

Each dynamic node must contain the following fields: Key and Next. The Key field holds a key value. The Next field points to the following node in the linked list if any, or has a null value otherwise. The lowest bit of Next (if set) indicates a deleted node. The Next pointer can spare a bit, since pointers are at least 8-byte aligned on all current major systems.

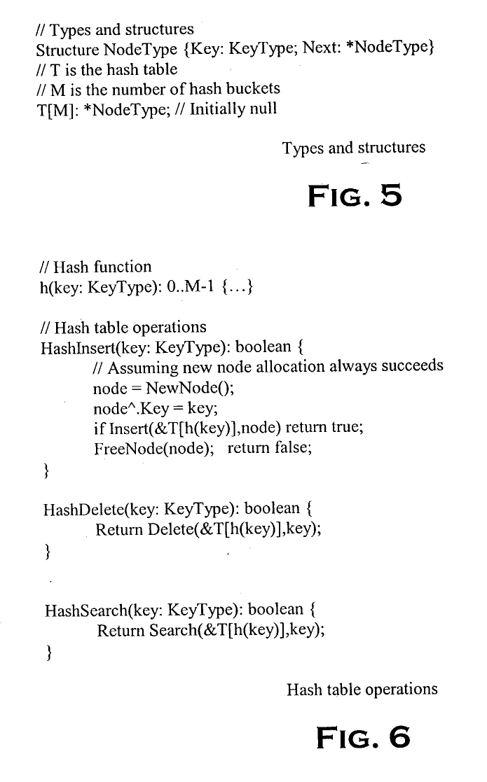

FIG. 5 shows exemplary data structures used by a hash table algorithm based on lock-free GC-independent linked-list algorithm. FIG. 6 shows hash table functions that use this algorithm. Basically, every hash table operation, maps the input key to a hash bucket and then calls the corresponding list-based set function with the address of the bucket header as an argument.

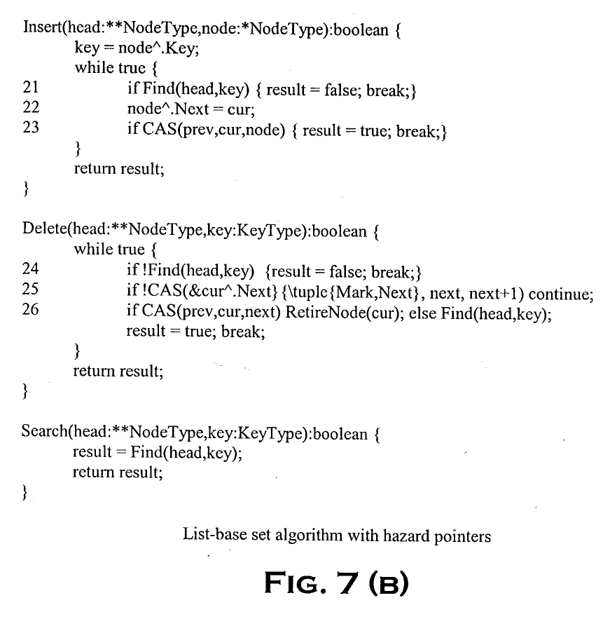

FIG. 7 shows an exemplary list-based set algorithm with hazard pointers The function Find (described later in detail) returns a Boolean value indicating whether a node with a matching key was found in the list. In either case, by its completion, it guarantees that the private variables prev, cur, and next have captured a snapshot of a segment of the list including the node (if any) that contains the lowest key value greater than or equal to the input key and its predecessor pointer. Find guarantees that there was a time during its execution when *prev was part of the list, *prev=cur, and if cur ≠ null, then also at that time cur\hat{ }.Next=next and cur\hat{ }.Key was the lowest key value that is greater than or equal to the input key. If cur=null then it must be that at that time all the keys in the list were smaller than the input key. Note that, we assume a sequentially consistent memory model. Otherwise, memory barrier instructions need to be inserted in the code between memory accesses whose relative order of execution is critical.

An Insert operation returns false if the key is found to be already in the list. Otherwise, it attempts to insert the new node, containing the new key, before the node cur\hat{ }, in one atomic step using CAS in line 23 after setting the Next pointer of the new node to cur, as shown in FIG. 7. The success of the CAS in line 23 is the linearization point of an Insert of a new key in the set. The linearization point of an Insert that returns false (i.e., finds the key in the set) is discussed later when presenting Find.

The failure of the CAS in line 23 implies that one or more of three events must have taken place since the snapshot in Find was taken. Either the node containing *prev was deleted (i.e. The mark bit in Next is set), the node cur\hat{ } was deleted and removed (i.e., no longer reachable from head), or a new node was inserted immediately before cur\hat{ }.

A Delete operation returns false if the key is not found in the list, otherwise, cur\hat{ }.Key must have been equal to the input key. If the key is found, the thread executing Delete attempts to mark cur\hat{ } as deleted, using the CAS in line 25, as shown in FIG. 7. If successful, the thread attempts to remove cur\hat{ } by swinging *prev to next, while verifying that the mark bit in *prev is clear, using the CAS in line 26.

The technique of marking the next pointer of a deleted node in order to prevent a concurrent insert operation from linking another node after the deleted node was used earlier in Harris' lock-free list-based set algorithm, and was first used in Prakash, Lee, and Johnson's lock-free FIFO queue algorithm.

RetireNode prepares the removed node for reuse and its implementation is dependent on the memory management method.

The success of the CAS in line 25 is the linearization point of a Delete of a key that was already in the set. The linearization point of a Delete that does not find the input key in the set is discussed later when presenting the Find function.

The failure of the CAS in line 25 implies that one or more of three events must have taken place since the snapshot in Find was taken. Either the node cur\hat{ } was deleted, a new node was inserted after cur\hat{ }, or the node next\hat{ } was removed from the list. The failure of the CAS in line 26 implies that another thread must have removed the node cur\hat{ } from the list after the success of the CAS in line 25 by the current thread. In such a case, a new Find is invoked in order to guarantee that the number of deleted nodes not yet removed never exceeds the maximum number of concurrent threads operating on the object.

The Search operation simply relays the response of the Find function.

The Find function starts by reading the header of the list *head in line 2. If the Next pointer of the header is null, then the list must be empty, therefore Find returns false after setting prev to head and cur to null. The linearization point of finding the list empty is the reading of *head in line 2. That is, it is the linearization point of all Delete and Search operations that return false after finding the set empty.

If the list is not empty, a thread executing Find traverses the nodes of the list using the private pointers prev, cur, and next. Whenever it detects a change in *prev, in lines 8 or 13, it starts over from the beginning. The algorithm is lock-free. A change in *prev implies that some other threads have made progress in the meantime.

A thread keeps traversing the list until it either finds a node with a key greater than or equal to the input key, or reaches the end of the list without finding such node. If it is the former case, it returns the result of the condition cur\hat{ }.Key=key at the time of its last execution of the read in line 12, with prev pointing to cur\hat{ }.Next and cur\hat{ }.Key is the lowest key in the set that is greater than or equal the input key, at that point (line 6). If the thread reaches the end of the list without finding a greater or equal key, it returns false, with *prev pointing to the fields of the last node and cur=null.

In all cases of non-empty lists, the linearization point of the snapshot in Find is the last reading of cur\hat{ }.Next (line 6) by the current thread. That is, it is the linearization point of all Insert operations that return false and all Search operations that return true, as well as all Delete and Search operations that return false after finding the set non-empty.

During the traversal of the list, whenever the thread encounters a marked node, it attempts to remove it from the list, using CAS in line 8. If successful, the removed node is prepared for future reuse in RetireNode.

Note that, for a snapshot in Find to be valid, the mark bits in *prev and cur\hat{ }.Next must be found to be clear. If a mark is found to be set the associated node must be removed first before capturing a valid snapshot.

On architectures that support restricted LL/SC but not CAS, implementing CAS(addr,exp,new) using the following routine suffices for the purposes of the new methods.

while true {if LL(addr) ≠ exp return false; if SC(addr,new)return true;}

In the Find function, there are accesses to dynamic structures in lines 6, 8, 12 and 13, and the addresses of dynamic nodes are used as expected values of ABA-prone validation conditions and CAS operations in lines 8 and 13.

Lines 4 and 5 serve to guarantee that the next time a thread accesses cur\hat{ } in lines 6 and 12 and executes the validation condition in line 13, it must be the case that the hazard pointer *hp0 has been continuously pointing to cur\hat{ } from a time when it was in the list, thus guaranteeing that cur\hat{ } is not free during the execution of these steps.

The ABA problem is impossible in the validation condition in line 13 and the CAS in line 8, even if the value of *prev has changed since last read in line 2 (or line 6 for subsequent loop executions). The removal and reinsertion of cur\hat{ } after line 2 and before line 5 do not cause the ABA problem in lines 8 and 13. The hazardous sequence of events that can cause the ABA problem in lines 8 and 13 is if cur\hat{ } is removed and then reinserted in the list after line 6 and before lines 8 and 13. The insertion and removal of other nodes between *prev and cur\hat{ } never causes the ABA problem in lines 8 and 13. Thus, by preventing cur\hat{ } from being removed and reinserted during the current thread's execution of lines 6-8 or 6-13, hazard pointers make the ABA problem impossible in lines 8 and 13.

Line 16 serves to prevent cur\hat{ } in the next iteration of the loop (if any) from being removed and reinserted during the current thread's execution of lines 6-8 or 6-13, and also to guarantee that if the current thread accesses cur\hat{ } in the next iteration in lines 6 and 12, then cur\hat{ } is not free.

The protection of cur\hat{ } in one iteration continues in the next iteration for protecting the node containing *prev, such that it is guaranteed that when the current thread accesses *prev in lines 6 and 12, that node is not free. The same protections of *prev and cur\hat{ } continue through the execution of lines 23, 25, and 26.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. A computer-implemented method for managing a shared, lock-free dynamic data structure in a multithreaded operating environment, comprising the steps of:
setting a hazard pointer to an address of a portion of a data structure to be removed;
removing the portion of the data structure; and
ensuring that memory associated with the removed portion of the data structure is freed only when the hazard pointer no longer points to the removed portion of the data structure.

2. The computer-implemented method of claim 1, wherein each thread sharing the dynamic data structure has at least one hazard pointer.

3. The computer-implemented method of claim 1, wherein a thread setting the hazard pointer is different from a thread freeing the portion of the data structure.

4. The computer-implemented method of claim 3, wherein the thread setting the hazard pointer ensures that it accesses a portion of the data structure to be removed, only if the hazard pointer continuously points to the portion of the data structure to be removed from a time when it was not removed.

5. The computer-implemented method of claim 1, wherein the data structure is a linked-list data structure.

6. The computer-implemented method of claim 1, wherein the portion of the data structure is a node.

7. The computer-implemented method of claim 6, wherein the linked-list data structure implements one of a stack, a queue, a heap, and a hash table.

8. The computer-implemented method of claim 1, further including the step of scanning the removed portions of the data structure to determine ones of the removed portions that can be safely freed.

9. The computer-implemented method of claim 8, wherein the removed portions of the data structure are scanned only when the number of removed portions exceeds a predetermined value.

10. The computer-implemented method of claim 8, wherein the removed portions of the data structure are scanned only when the number of removed portions equals or exceeds a value proportionate to the number of threads.

11. The computer-implemented method of claim 8, wherein the scanning step includes:
creating a sorted list of hazard pointers; and
searching the sorted list of hazard pointers to determine matches between any of the hazard pointers and the removed portions.

12. The computer-implemented method of claim 11, wherein the searching step is performed using a binary search.

13. The computer-implemented method of claim 12, wherein the created sorted list of hazard pointers includes only non-null hazard pointers.

14. The computer-implemented method of claim 1, wherein hazard pointers associated with threads not using the data structure are set to null.

15. The computer-implemented method of claim 1, wherein only single-word read and write operations are used for memory access.

16. The computer-implemented method of claim 1, wherein only single-word operations are used for memory access.

17. The computer-implemented method of claim 1, wherein operations on the data structure are guaranteed to proceed concurrently without any one of the operations preventing other operations from completing indefinitely.

18. The computer-implemented method of claim 1, wherein freed portions of the data structure are freed for arbitrary reuse.

19. A program storage device readable by a machine, tangibly embodying a program of instructions executable on the machine to perform method steps for managing a shared dynamic data structure in a multithreaded operating environment, the method steps comprising:
setting a hazard pointer to an address of a portion of a data structure to be removed;
removing the portion of the data structure; and
ensuring that memory associated with the removed portion of the data structure is freed only when the hazard pointer no longer points to the removed portion of the data structure.
